(19) United States
(12) Patent Application Publication
(10) Pub. No.: US 2026/0159452 A1
(43) Pub. Date: Jun. 11, 2026

(54) HIGH TEMPERATURE COMPOSITES AND METHODS FOR PREPARING HIGH TEMPERATURE COMPOSITES

(71) Applicant: ARKEMA FRANCE, COLOMBES (FR)

(72) Inventors: Robert BARSOTTI, King of Prussia, PA (US); Krysten MINNICI, King of Prussia, PA (US); Stephen G. DIPIETRO, Amherst, PA (US); Mary CALVIN, Havertown, PA (US); Roderick REBER, Philadelphia, PA (US)

(73) Assignee: ARKEMA FRANCE, COLOMBES (FR)

(21) Appl. No.: 18/707,026

(22) PCT Filed: Nov. 15, 2022
(86) PCT No.: PCT/US2022/049962

§ 371 Date: May 3, 2024

Related U.S. Application Data
(63) Continuation of application No. 17/530,970, filed on Nov. 19, 2021, now Pat. No. 12,497,335.

(30) Foreign Application Priority Data
Nov. 15, 2021 (EP) 21306580.8

(51) Int. Cl. C04B 35/83; C04B 35/628; C04B 35/64; C04B 35/657

(52) U.S. Cl. CPC C04B 35/83; C04B 35/62873; C04B 35/62886; C04B 35/64; C04B 35/657; C04B 2235/422; C04B 2235/48; C04B 2235/5248; C04B 2235/5256; C04B 2235/616

(57) ABSTRACT

The invention concerns:
A method for making a high temperature composite, which is a carbon carbon composite, a carbon ceramic matrix composite, or a carbon silica composite, comprising:
a. making a precursor part from a resin comprising a poly(aryl ether ketone) (PAEK) copolymer comprising at least two different repeating units, one of the repeating units being present in an amount of 50 to 78 mol % compared to the total amount of the repeating units constituting the copolymer, and at least one reinforcing material;
b. pyrolyzing the precursor part to a pyrolyzed part;
c. infusing a liquid second resin into the pyrolyzed part to make an infused part; and
d. pyrolyzing the infused part to make the carbon carbon composite, the carbon ceramic matrix composite, or the carbon silica composite,
   optionally repeating steps c. through d. one or more times.

### FIELD

The present invention relates to high temperature composites, such as carbon carbon composites, carbon ceramic matrix composites, and carbon silica composites. The present invention also relates to methods for preparing high temperature composites, such as carbon carbon composites, carbon ceramic matrix composites, and carbon silica composites.

### BACKGROUND

High temperature composites such as carbon carbon composites, carbon ceramic matrix composites, and carbon silica composites, can be useful in areas such as hypersonics, solid/liquid rocket propulsion, and other defense/aerospace applications where ultra high temperature properties are required. Industrial applications can include metal and glass processing and concentrated photovoltaics.

High temperature composites materials, including carbon composites, carbon ceramic matrix composites and carbon silica composites have been traditionally made utilizing pitch or thermoset resins such as phenolic (such as Hexion Durite SC1008) or epoxy. Precursor parts utilizing these thermoset composites are made by a “hand lay-up” requiring significant manual labor to place thermoset prepregs down. In addition to the time and cost of such labor, this manual effort also leads to human error and low quality in precursor parts. Thermoplastic composite materials have an advantage in their ability to be processed by automated methods, including automated tape placement and 3D printing. Thermoplastic tape has additional advantages versus thermoset prepregs in that refrigerated shipment and storage is typically not required.

A pyrolysis step (thermal treatment) can be used in the production of carbon carbon composites, carbon ceramic matrix composites, and carbon silica composites. The pyrolysis can be implemented to eliminate volatiles and/or non-carbon organic elements in the composites (such as in the polymer matrix) and retain the carbon elements.

But pyrolysis steps can sometimes take hundreds of hours, with an additional day for graphitization. This process is then repeated several times, leading to long lead times for finished parts. Each additional re-infusion plus pyrolysis cycle is labor intensive and time consuming. Additionally, at each cycle there is the possibility that errors or defects could lead to an unacceptable final object. Therefore, it is desirable to reduce the number of cycles required to achieve a fully dense part. Higher char yields allow this process to be shortened because the part is closer to fully solid after the first pyrolysis cycle thereby lessening the number of needed cycles. Typically phenolic based solutions can only provide char yields of 50-70%. Many other (non PAEK) thermoplastic solutions provide char yields of less than 65%.

Defect to be avoided, notably occurring during the pyrolyzing steps, are dimensional changes of the part being pyrolyzed, in particular bloating of the part and/or cracks appearing within the part.

The inventions described herein, which utilize selected poly(aryl ether ketone) (PAEK) copolymers, unexpectedly overcome at least some of the above mentioned problems.

PAEK polymers, are high performance semi-crystalline polymers having high melting points, extremely high thermal properties, outstanding chemical resistance and flame resistance, and high modulus and strength. By following embodiments of the invention, it is possible to make carbon carbon composites, carbon ceramic matrix composites, and carbon silica composites using a thermoplastic resin. The thermoplastic resin allows automated methods to make precursors parts thereby saving time and money while improving quality and having unexpectedly high char yields, such as char yields from 70% to 80%, up to 85%, up to 90%, and even up to 95% and higher. Pyrolysis cycles can be sped up as the PAEK materials show a single decomposition point thereby alleviating the need for long hold cycles at multiple temperatures often seen with thermoset resins. The surprisingly high char yields also enable fewer pyrolysis/infusion steps than other methods, thereby savings days and even weeks of production time. In certain embodiments, the carbon carbon composites, carbon ceramic matrix composites, and carbon silica composites can be made in a total process time of less than about 50 h, 60 h, 70 h, 80 h, 90 h, 100 h, 110 h, 120 h, 130 h, 140 h, 150 h, 160 h, 170 h, 180 h, 190 h, 200 h, or any ranges between the specified values.

The Applicant has also surprisingly discovered that, thanks notably to the selection of poly(aryl ether ketone) (PAEK) copolymers, it is possible to utilize carbon carbon composite, carbon ceramic matrix composite, and carbon silica composite precursors that combine the advantages of high char yields and high mechanical performance of PAEK polymers with low dimensional changes of the part being pyrolyzed.

### SUMMARY

The invention is directed to a method for making a high temperature composite, which is a carbon carbon composite, a carbon ceramic matrix composite, or a carbon silica composite, comprising:
a. making a precursor part from a resin comprising a poly(aryl ether ketone) (PAEK) copolymer comprising at least two different repeating units, one of the repeating units being present in an amount of 50 to 78 mol % compared to the total amount of the repeating units constituting the copolymer, and at least one reinforcing material;
b. pyrolyzing the precursor part to a pyrolyzed part;
c. infusing a liquid second resin into the pyrolyzed part to make an infused part; and
d. pyrolyzing the infused part to make the carbon carbon composite, the carbon ceramic matrix composite, or the carbon silica composite, optionally repeating steps c. through d. one or more times.

In certain embodiments, the PAEK copolymer essentially consists of, or consists of two repeating units. In certain embodiments, the PAEK copolymer is a polyetherketoneketone (PEKK) having a T:I ratio of from 50:50 to 78:22, preferably from 55:45 to 75:25. In certain embodiments, the PEKK has a T:I ratio of about 55:45 to about 65:35. In certain embodiments, the PEKK has a T:I ratio of about 65:35 to about 75:25.

In certain embodiments, during the pyrolyzing, a temperature within a chamber increases to a peak temperature of about 1000° C. or more.

In certain embodiments, a temperature within a chamber increases one or more times at a rate from 1° C./h to about 20° C./h during said pyrolyzing, and wherein optionally said pyrolyzing is maintained for a period of time at one or more temperatures.

In certain embodiments, during the pyrolyzing, a temperature within a chamber increases to a peak temperature of about 1000° C. or more and the temperature within the chamber increases one or more times at a rate from 1° C./h to about 20° C./h during said pyrolyzing, and wherein optionally said pyrolyzing is maintained for a period of time at one or more temperatures.

In certain embodiments, during the pyrolyzing of the precursor part, the temperature within the chamber increases one or more times at a rate of less than 10° C./h between 450° C. and 600° C., and is optionally maintained for a period of time at one or more temperatures between 450° C. and 600° C., temperatures included.

In certain embodiments, during the pyrolyzing of the precursor part, the temperature within the chamber increases one or more times at a rate of 10° C./h or more at temperatures below 400° C. and/or above 650° C.

In certain embodiments, the liquid second resin comprises one or more of pitch, benzoxazines, furfural, polyester, vinylester, acrylic, and phenolics.

In certain embodiments, the precursor part is made by melt processing the resin comprising the poly(aryl ether ketone) and the at least one reinforcing material. In certain embodiments, the melt processing comprises one or more of injection molding, extrusion, roto-molding, compression molding, pultrusion, filament winding, and fused filament fabrication printing.

In certain embodiments, the precursor part of step (a) is made by:
a1) impregnating a continuous fiber tape or fabric with a resin comprising a poly(aryl ether ketone) (PAEK) copolymer comprising at least two different repeating units, one of the repeating units being present in an amount of 50 to 78 mol % compared to the total amount of the repeating units constituting the copolymer, and at least one reinforcing additive to make a filled PAEK tape or fabric or, co-weaving a continuous fiber or fabric with a PAEK fiber comprising PAEK and the at least one reinforcing additive to make a filled co-woven PAEK fiber or fabric; and
a2) processing the filled PAEK tape or fabric or co-woven PAEK fiber or fabric via one or more the following methods: hand-layup, automated tape placement, 3D printing, filament winding, needle punching, and other methods of Z-axis reinforcement followed by one or more compression molding, vacuum bag consolidation, autoclave consolidation, and in-situ consolidation, to make the precursor part.

In certain embodiments, the precursor part of step (a) is made by:
a1) processing an aligned reinforcing material and a resin comprising a PAEK copolymer comprising at least two different repeating units, one of the repeating units being present in an amount of 50 to 78 mol % compared to the total amount of the repeating units constituting the copolymer, to make an aligned reinforcing material PAEK composition, to create a fabric, prepreg, or tape comprising the aligned reinforcing material and impregnated PAEK,
a2) processing the fabric, prepreg, or tape comprising the aligned reinforcing material and impregnated PAEK via hand-layup, automated tape placement, 3D printing, filament winding, or needle punching or other methods of Z-axis reinforcement followed by compression molding, vacuum bag consolidation, autoclave consolidation, in-situ consolidation to make a precursor object.

In certain embodiments, the reinforcing material comprises one or more reinforcing additives chosen among a carbonaceous additive, a chopped fiber, an inorganic additive, or mixtures thereof; a fibrous material comprising long fibers, continuous fibers, or mixtures thereof; or mixtures thereof.

In certain embodiments, the reinforcing material comprises a carbonaceous additive being one or more of carbon fiber, carbon nanotubes, graphite, graphene, carbon whisker, a fullerene, carbon black, carbon flake, buckyballs and mixtures thereof.

In certain embodiments, the reinforcing material comprises a chopped, long, or continuous fiber being one or more of carbon, glass, silica, boron, natural fibers, polymeric fibers and mixtures thereof.

In certain embodiments, the reinforcing material is a chopped carbon fiber or a chopped glass fiber.

In certain embodiments, the reinforcing material is a long or continuous carbon fiber, or a long or continuous glass fiber.

In certain embodiments, the reinforcing material comprises an inorganic additive being one or more of a group IV, V, or VI carbide, silicide, boride, or nitride, and/or ceramic whiskers.

In certain embodiments, the precursor part comprises a dispersing agent being an organosilicate, oganozirconate, organoaluminate or oraganotitanate.

In certain embodiments, the reinforcing material is a mixture of chopped fibers and, long or continuous fibers.

In certain embodiments, the precursor part of step (a) is made by: processing a tape or fabric or co-woven PAEK fiber or fabric made of a PAEK copolymer comprising at least two different repeating units, one of the repeating units being present in an amount of 50 to 78 mol % compared to the total amount of the repeating units constituting the copolymer, and at least one reinforcing material, via one or more the following methods: hand-layup, automated tape placement, 3D printing, filament winding, needle punching, and other methods of Z-axis reinforcement followed by one or more compression molding, vacuum bag consolidation, autoclave consolidation, and in-situ consolidation.

The invention is also directed to a carbon carbon composite, carbon ceramic matrix composite, or carbon silica composite made by the method of the invention.

### DETAILED DESCRIPTION

Embodiments of the disclosure relate to methods for preparing high temperature composites, such as carbon carbon composites, carbon ceramic matrix composites, and carbon silica composites. Embodiments of the disclosure also relate to carbon carbon composites, carbon ceramic matrix composites, and carbon silica composites made by the disclosed methods.

As used herein, the term “about” means±10% of the noted value. By way of example only, at least “about 50 percent” could include from at least 45 percent to and including at least 55 percent.

The word “comprising” is used in a manner consistent with its open-ended meaning, that is, to mean that a given product or process can optionally also have additional features or elements beyond those expressly described. It is understood that wherever embodiments are described with the language “comprising,” otherwise analogous embodiments described in terms of “consisting of” and/or “consisting essentially of” are also contemplated and within the scope of this disclosure.

As used herein, the term “aligned” means where >75% of objects have at least one of their major axis oriented (±5°) in the same direction, as measured using images from optical microscopy of cross sections of the composites.

As used herein, the term “char yield” refers to residual carbon content measured by weight remaining after pyrolysis, and can be determined as set forth in the Example herein.

As used herein in the context of the composite, the term “% solid” means the percent (%) of density of pyrolyzed part compared to a theoretical fully dense part containing no vacancies or voids. The density of the fully dense part can be calculated by the Rule of mixtures of the matrix material (carbon or ceramic) and the fibrous material (glass or carbon).

$$D = d 1 a + d 2 ( 1 - a )$$

### Where

D=density of the fully dense part
d1=density of the fibrous material (glass or carbon)
a=weight fraction of the fibrous material (glass or carbon)
d2=density of the matrix material (carbon or ceramic)
   The density of the pyrolyzed part can be experimentally measured by dividing its mass by its volume.

As used herein, the term “composite” means material comprising at least two different and/or distinct components. For example and without limiting, carbon-carbon composites may comprise a carbon matrix (e.g., graphitic) with carbon fibers. A carbon ceramic matrix composite may comprise a ceramic matrix (e.g., SiC) with carbon. A carbon silica composite can comprise a carbon (typically graphitic) matrix with glass/silica fibers.

As used herein, the term “high temperature”, when used in the expression high temperature composite, means and refer to a temperature of or above about 1000° C., at which the composite is able to be used without detrimental degradation,

As used herein, the term “pyrolyzing” means to enact a chemical change to a material via the application of heat, causing some, substantially all, or all non-carbon or non-inorganic elements of the materials to volatize away. In the present invention, the chemical change of the precursor generally occurs at a temperature of at least 250° C., and notably at a temperature of at least 400° C.

As used herein, the term “infuse” (or “infusing”) means to cause a matrix to be penetrated with a liquid resin, and can fill in voids or vacancies.

As used herein, the term “chopped” refers to fibers that are not continuous and have lengths of about ≤20 mm, preferably of about ≤15 mm, preferably of about ≤10 mm and most preferably of about <5 mm.

As used herein, the term “polyaryl ether ketone”, commonly referred to by its acronym “PAEK”, includes repeating units having the following formulae:

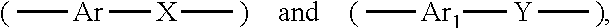

in which:
Ar and Ar₁ each denote a divalent aromatic radical;
Ar and Ar₁ may preferably be chosen from 1,3-phenylene, 1,4-phenylene, 1,1′-biphenylene divalent in positions 3,3′,1,1′-biphenyl divalent in positions 3,4′,1,4-naphthylene, 1,5-naphthylene and 2,6-naphthylene;
X denotes an electron-withdrawing group; it may preferably be chosen from the carbonyl group and the sulfonyl group;
Y denotes a group chosen from an oxygen atom, a sulfur atom or an alkylene group, such as —(CH₂)— and isopropylidene.

In these units X and Y, at least 50%, preferably at least 70% and more particularly at least 80% of the groups X are a carbonyl group, and at least 50%, preferably at least 70% and more particularly at least 80% of the groups Y represent an oxygen atom.

According to a preferred embodiment, 100% of the groups X may represent a carbonyl group and 100% of the groups Y may represent an oxygen atom.

### PAEK Copolymer

The PAEK used in the invention is a copolymer, which means that it has at least two repeating units of different chemical structure. One of the repeating units is present in an amount of 50 mol % to 78 mol % compared to the total mole amount of the repeating units constituting the copolymer. Indeed, the inventors have noticed that the presence of two different repeating units into the PAEK structure participated in minimizing the PAEK dimensional change during the pyrolyzing.

In some embodiments, the PAEK copolymer essentially consists of, or consists of, two repeating units of different chemical structure. As used herein, the term “essentially consisting of repeating units” means that the repeating units represent a molar proportion of from 95% to 99.9% in the polymer. In addition, the term “consisting of repeating units” means that the repeating unit(s) represent a molar proportion of at least 99.9%, ideally of 100%, in the polymer.

In some embodiments, the repeating unit predominately present in the copolymer structure represents from 55 mol % to 75 mol % compared to the total mole amount of the repeating units constituting the copolymer.

Advantageously, the PAEK copolymer may be chosen from:
a polyether ketone ketone copolymer, also known as PEKK; a PEKK essentially consists of, or consists of one or more repeat units of formula: -Ph-O-Ph-C(O)-Ph-C(O)—;
a polyether ether ketone copolymer, also known as PEEK; a PEEK essentially consists of, or consists of one or more repeat units of formula: -Ph-O-Ph-O-Ph-C(O)—;
a polyether ketone copolymer, also known as PEK; a PEK essentially consists of, or consists of one or more repeat units of formula: -Ph-O-Ph-C(O)—;
a polyether ether ketone ketone copolymer, also known as PEEKK; a PEEKK essentially consists of, or consists of one or more repeat units of formula: -Ph-O-Ph-O-Ph-C(O)-Ph-C(O)—;
a polyether ether ether ketone copolymer, also known as PEEEK; a PEEEK essentially consists of, or consists of one or more repeat units of formula: -Ph-O-Ph-O-Ph-O-Ph-C(O)—;
a polyether diphenyl ether ketone copolymer, also known as PEDEK; a PEDEK essentially consists of, or consists of one or more repeat units of formula: -Ph-O-Ph-Ph-O-Ph-C(O)—;
and mixtures thereof; and
copolymers comprising at least two of the abovementioned repeat units,
   in which: Ph represents a phenylene group and —C(O)— represents a carbonyl group, each of the phenylenes possibly being, independently, of the ortho (1-2), meta (1-3) or para-(1-4) type, preferentially being of meta or para type.

In particular embodiments, the PAEK may be a PEKK essentially consisting of, or consisting of, a terephthalic repeating unit and an isophthalic repeating unit, the terephthalic repeating unit having the formula (“T unit”):

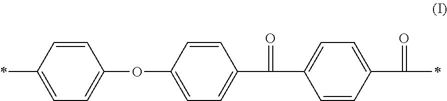

the isophthalic repeating unit having the formula (“I unit”):

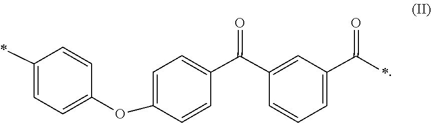

The “T unit” may also be written: -A-C(═O)—B—C(═O)—, and the “I unit” may also be written: -A-C(═O)-D-C(═O)—, where A is a p,p′-Ph-O-Ph- group, Ph is a phenylene radical, B is p-phenylene, and D is m-phenylene.

According to the invention, when the PAEK is a PEKK, the Formula I: Formula II (T:I) isomer ratio in the polyetherketoneketone ranges advantageously from 50:50 to 78:22. The isomer ratio can be easily varied as can be desired to achieve a certain set of properties, e.g., by varying the relative amounts of the different monomers used to make the polyetherketoneketone. These T:I isomer ratios enable to both maximize the char yield and minimize the precursor part dimensional deformation of the pyrolyzed part.

In preferred embodiments, the polyetherketoneketone copolymer can have a T:I isomer ratio of 55:45 to 75:25. In some embodiments, the polyetherketoneketone can have a T:I isomer ratio of about 55:45 to about 65:35, notably about 60:40. In some other embodiments, the polyetherketoneketone can have a T:I isomer ratio of about 65:35 to about 75:25, notably about 70:30.

Suitable polyetherketoneketones are sold under the brand name KEPSTAN® supplied by Arkema.

In particular embodiments, the PAEK may be a polymer consisting essentially of, or even consisting of:
a repeat unit of formula:

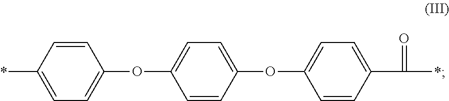

and a repeat unit:

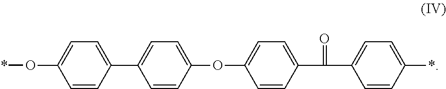

In certain embodiments, the PAEK copolymer can have a molar ratio of unit (III) to unit (IV) of 55:45 to 75:25.
In certain embodiments, the PAEK copolymer can have a molar ratio of unit (IV) to unit (III) of 55:45 to 75:25.

In particular embodiments, the PAEK may be a polymer consisting essentially of, or consisting of:
a repeating unit of formula:

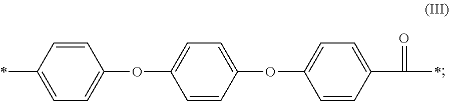

and a repeating unit of formula:

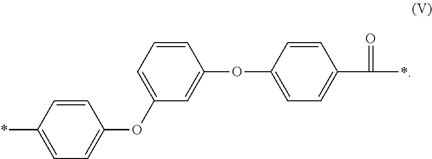

In certain embodiments, the PAEK copolymer can have a molar ratio of unit (III) to unit (V) of 55:45 to 75:25.
In certain embodiments, the PAEK copolymer can have a molar ratio of unit (V) to unit (III) of 55:45 to 75:25.

### Reinforcing Material

The reinforcing material of the invention may be an additive, a fibrous material, or a mixture thereof.

In certain embodiments, the reinforcing material can be present in an amount of about 0.1%, 0.5%, 1%, 5%, 10%, 15%, 20%, 25%, 30%, 35%, 40%, 45%, 50%, 55%, 60%, 65%, 70%, 80% or any ranges between the specified values, based on the weight of the total composition of the resin of the precursor part after melt processing.

When the reinforcing material is a reinforcing additive, it means for the present invention that the reinforcing material is discrete. It notably does not encompass long fibers, continuous fibers, or other materials considered as fibrous material. Among fibers, the reinforcing additive notably does not encompass fibers having a length of >20 mm, or in some embodiment fibers having a length of >15 mm, or of >10 mm, or of >5 mm. The advantage of using reinforcing additives to make the precursor part is that it enables to increase the char content of the pyrolyzed part and improves its mechanical properties compared to a comparative part which would be made of only a polyaryletherketone. At the same time, a precursor part comprising a PAEK and at least one reinforcing additive is much easier to process than a precursor part which would be made of a PAEK with long, continuous fibers, or other materials considered as fibrous material.

In certain embodiments, the reinforcing material is a reinforcing additive. It can be present in an amount of from about 0.1% to about 70% by weight of the total composition of the resin. In certain embodiments, the reinforcing additive can be present in an amount of from about 1% to about 60% by weight of the total composition of the resin. In certain embodiments, the reinforcing material can be present in an amount of from about 5% to about 50% by weight of the total composition of the resin of the precursor part after melt processing.

In preferred embodiments, the reinforcing additive can be present in an amount of between 20% and 45%, notably of 25% to 40%, based on the weight of the total composition of the resin of the precursor part after melt processing.

In certain advantageous embodiments, the reinforcing additive can be one or more of a carbonaceous additive, a chopped fiber, dispersing agents, and an inorganic additive or mixtures thereof.

In certain embodiments, the carbonaceous additive can be one or more of carbon fiber, carbon nanotubes, graphite, graphene, carbon whisker, a fullerene, carbon black, carbon flake, and buckyballs and mixtures thereof. In certain embodiments, the carbonaceous additive can be aligned by shear from the melt processing.

In certain embodiments, the carbonaceous additive can have a length of from about 0.1 mm to 10 mm, from about 0.5 mm to 9 mm, or from about 1 mm to 8 mm. In certain embodiments, the carbonaceous additive can have a length of about 0.1 mm, 0.5 mm, 1 mm, 2 mm, 3 mm, 4 mm, 5 mm, 6 mm, 7 mm, 8 mm, 9 mm, 10 mm, and any ranges between the specified values. In certain embodiments, the carbonaceous additive can have a diameter of from about 0.1 μm to 10 μm, from about 0.5 μm to 9 μm, or from about 1 μm to 8 μm. In certain embodiments, the carbonaceous additive can have a diameter of about 0.1 μm, 0.5 μm, 1 μm, 2 μm, 3 μm, 4 μm, 5 μm, 6 μm, 7 μm, 8 μm, 9 μm, 10 μm, and any ranges between the specified values. The length of additive can be measured via optical microscopy before melt compounding. The diameter of additive can be measured via scanning electron microscopy.

In certain embodiments, the reinforcing additive can be a chopped fiber. In certain embodiments, the chopped fiber comprises one or more of carbon, glass, silica, boron, natural fibers, and polymeric fibers and mixtures thereof. In certain embodiments, the natural fibers can be one or more of cellulose, bamboo, hemp, and jute. In certain embodiments, the polymeric fibers can be one or more of polyamide, polyimides, polyaramid, polyurethane, polyester, and polyurethane, and mixtures thereof.

In certain embodiments, the chopped fiber is a chopped carbon fiber. The one or more carbon fibers can have a fiber length of from about 0.1 mm to 10 mm, from about 0.5 mm to 9 mm, or from about 1 mm to 8 mm. In certain embodiments, the chopped carbon fiber can have a fiber length of about 0.1 mm, 0.5 mm, 1 mm, 2 mm, 3 mm, 4 mm, 5 mm, 6 mm, 7 mm, 8 mm, 9 mm, 10 mm, and any ranges between the specified values. In certain embodiments, the chopped carbon fiber can have a diameter of from about 0.1 μm to 10 μm, from about 0.5 μm to 9 μm, or from about 1 μm to 8 μm. In certain embodiments, the chopped carbon fiber can have a diameter of about 0.1 μm, 0.5 μm, 1μ, 2μ, 3 μm, 4 μm, 5 μm, 6 μm, 7 μm, 8 μm, 9 μm, 10 μm, and any ranges between the specified values. The length of additive can be measured via optical microscopy before melt compounding. The diameter of additive can be measured via scanning electron microscopy.

One preferred embodiment is directed to chopped carbon fiber at a loading level of 10-45%, or 15-40%, or 20-35% as measured by weight in a PEKK matrix having a T:I ratio of 50:50 to 78:22.

More preferred embodiments are directed to chopped carbon fiber at a loading level of between 20% and 45%, notably of 25% to 40% as measured by weight in a PEKK matrix having a T:I ratio of 50:50 to 78:22, notably a T:I ratio of about 60:40 or of about 70:30.

In certain embodiments, the chopped fiber is a chopped glass fiber. The one or more glass fibers can have a fiber length of from about 0.1 mm to 10 mm, from about 0.5 mm to 9 mm, or from about 1 mm to 8 mm. In certain embodiments, the chopped glass fiber can have a fiber length of about 0.1 mm, 0.5 mm, 1 mm, 2 mm, 3 mm, 4 mm, 5 mm, 6 mm, 7 mm, 8 mm, 9 mm, 10 mm, and any ranges between the specified values. In certain embodiments, the chopped glass fiber can have a diameter of from about 0.1 μm to 10 μm, from about 0.5 μm to 9 μm, or from about 1 μm to 8 μm. In certain embodiments, the chopped glass fiber can have a diameter of about 0.1 μm, 0.5 μm, 1 μm, 2 μm, 3 μm, 4 μm, 5 μm, 6 μm, 7 μm, 8 μm, 9 μm, 10 μm, and any ranges between the specified values. The length of additive can be measured via optical microscopy before melt compounding. The diameter of additive can be measured via scanning electron microscopy.

One preferred embodiment is directed to chopped glass fiber at a loading level of 10-45%, or 15-40%, or 20-35% as measured by weight in a PEKK matrix having a T:I ratio of 50:50 to 78:22.

More preferred embodiments are directed to chopped glass fiber at a loading level of between 20% and 45%, notably of 25% to 40% as measured by weight in a PEKK matrix having a T:I ratio of 50:50 to 78:22, notably a T:I ratio of about 60:40 or of about 70:30.

In certain embodiments, the inorganic additive can be one or more of a group IV, V, or VI carbide, silicids, boride, and nitride. In certain embodiments, the inorganic additive can be in powder form. In certain embodiments, the average particle size of the powder can be from about 0.01 μm to 500 μm, from about 0.1 μm to 250 μm, from about 1 μm to 100 μm, or from about 2 μm to 50 μm. In certain embodiments, the average particle size of the powder can be 0.01 μm, 0.1 μm, 0.5 μm, 1 μm, 5 μm, 10 μm, 15 μm, 20 μm, 25 μm, 30 μm, 40 μm, 50 μm, 75 μm, 100 μm, 250 μm, 500 μm, or any ranges between the specified values.

In certain embodiments, the reinforcing additive can comprise a dispersing agent. By dispersing agent is meant any moiety that improves separation of additives/particles and/or prevents clumping or settling. In certain embodiments, the dispersing agent can be an organosilicate, oganozirconate, organoaluminate, or oraganotitanate. In certain embodiments, dispersing agent can have an average particle size of from about 1 nm to 500 nm, from about 2 nm to 250 nm, or from 3 nm to 100 nm. In certain embodiments, dispersing agent can have an average particle size of about 1 nm, 2 nm, 3 nm, 5 nm, 10 nm, 15 nm, 20 nm, 25 nm, 30 nm, 40 nm, 50 nm, 75 nm, 100 nm, 250 nm, 500 nm, or any ranges between the specified values. Particle size can be determined by scanning electron microscopy of the dispersing agent before melt compounding.

As regards to reinforcing materials considered as fibrous materials, mention may be made of several fibers, uni directional rovings or continuous filament mat, fabrics, felts or nonwovens that may be in the form of strips, laps, braids, locks or pieces. The fibrous material may have various forms and dimensions, either one-dimensional, two-dimensional or three-dimensional. The fibrous material generally comprises an assembly of one or more long fibers or continuous fibers. When the fibres are continuous, their assembly forms fabrics.

The one-dimensional form corresponds to linear long fibers. The fibers may be discontinuous or continuous. The fibers may be arranged randomly or parallel to each other, in the form of a continuous filament. A fiber is defined by its aspect ratio, which is the ratio between the length and diameter of the fiber. The fibers of the fibrous material are long fibers or continuous fibers. These fibers generally have an aspect ratio of at least 1000, preferably at least 1500, more preferably at least 2000, advantageously at least 3000 and more advantageously at least 5000, even more advantageously at least 6000, more advantageously still at least 7500 and most advantageously at least 10 000.

The two-dimensional form corresponds to nonwoven or woven fibrous mats or reinforcements or bundles of fibers, which may also be braided. Even if the two-dimensional form has a certain thickness and consequently in principle a third dimension, it is considered as two-dimensional according to the present invention.

The three-dimensional form corresponds, for example, to nonwoven fibrous mats or reinforcements or stacked or folded bundles of fibers or mixtures thereof, an assembly of the two-dimensional form in the third dimension.

In certain embodiments, the long or continuous fibers may be one or more of carbon, glass, silica, boron, natural fibers, and polymeric fibers and mixtures thereof. In certain embodiments, the natural fibers can be one or more of cellulose, bamboo, hemp, and jute. In certain embodiments, the polymeric fibers can be one or more of polyamide, polyimides, polyaramid, polyurethane, polyester, and polyurethane, and mixtures thereof.

Preferably, the fibrous material is chosen from mineral fibers. More preferably the fibrous substrate is chosen from glass fibers or carbon fibers.

The fibers of the fibrous material may have a diameter between 0.005 μm and 100 μm, preferably between 1 μm and 50 μm, more preferably between 5 μm and 30 μm and advantageously between 10 μm and 25 μm.

The fibers of the fibrous material have a fiber length of >5 mm. In some embodiments, the fibers of the fibrous material have of >10 mm, or >15 mm, or >20 mm. In most cases, the fibers of the fibrous material have a fiber length of >20 mm.

In certain embodiments, the fibrous material can be present in an amount of from about 40% to about 80% by weight of the total composition of the resin. In certain embodiments, the fibrous material can be present in an amount of from about 45% to about 75% by weight of the total composition of the resin. In certain embodiments, the fibrous material can be present in an amount of from about 50% to about 70% by weight of the total composition of the resin of the precursor part.

One preferred embodiment is directed to long or continuous glass fibers present in an amount of 40-80%, or 45-75%, or 50-70% as measured by weight of the total composition of the resin of the precursor part, wherein the resin is PEKK having a T:I ratio of 50:50 to 78:22, notably a T:I ratio of about 60:40 or of about 70:30.

One other preferred embodiment is directed to long or continuous glass fibers present in an amount of 40-80%, or 45-75%, or 50-70% as measured by weight of the total composition of the resin of the precursor part, wherein the resin is PEKK having a T:I ratio of 50:50 to 78:22, notably a T:I ratio of about 60:40 or of about 70:30.

### Method of Manufacturing a High-Temperature Composite

The present disclosure is directed to a method for preparing a carbon carbon-composite, a carbon ceramic matrix composite, or a carbon silica composite.

In certain embodiments, the method for preparing a carbon-carbon composite, a carbon ceramic matrix composite, or a carbon silica composite comprises:
a. making a precursor part from a resin comprising a poly(aryl ether ketone) (PAEK) copolymer comprising at least two different repeating units, one of the repeating units being present in an amount of 50 to 78 mol % compared to the total amount of the repeating units constituting the copolymer, and at least one reinforcing material,
b. pyrolyzing the precursor part to make a pyrolyzed part,
C. infusing a liquid second resin into the pyrolyzed part to make an infused part, and
d. pyrolyzing the infused part to make the carbon-carbon composite, the carbon ceramic matrix composite, or the carbon silica composite, and
e. optionally repeating steps (c) through (d) one or more times.

In certain embodiments, the present disclosure is directed to the carbon-carbon composite, carbon ceramic matrix composite, or carbon silica composite made by the method above.

### Method Comprising Melt Processing

In certain embodiments, the method can comprise making a precursor part by melt processing.

In certain embodiments, the melt processing can be one or more of injection molding, extrusion, roto-molding, compression molding, pultrusion, filament winding and fused filament fabrication printing. In certain embodiments, the melt processing can optionally be followed by melt forming, such as thermoforming or rod bending.

The reinforcing material may be added to polyetherketoneketone as an additive and/or as a fibrous material.

According to the invention, during the pyrolyzing, a temperature within a chamber increases at a rate of from about 1° C./h to about 20° C./h up to a peak temperature of about 1000° C.

In certain embodiments, during the pyrolyzing the temperature within the chamber can increase at a rate of from about 3° C./h to about 17° C./h. In certain embodiments, during the pyrolyzing, the temperature within the chamber can increase at a rate of from about 5° C./h to about 15° C./h. In certain embodiments, pyrolysis conditions during pyrolyzing step b. are the same as the pyrolysis conditions during pyrolyzing step d. In certain embodiments, the pyrolysis conditions during pyrolyzing step b. are different than the pyrolysis conditions during pyrolyzing step d.

In certain embodiments, during the pyrolyzing, a temperature within a chamber can increase at a rate of from about 1° C./h, 2° C./h, 3° C./h, 4° C./h, 5° C./h, 6° C./h, 7° C./h, 8° C./h, 9° C./h, 10° C./h, 11° C./h, 12° C./h, 13° C./h, 14° C./h, 15° C./h, 16° C./h, 17° C./h, 18° C./h, 19° C./h, 20° C./h, or any ranges between the specified values.

In certain embodiments, during the pyrolyzing of the precursor part, the temperature within the chamber increases one or more times at a rate of 10° C./h or more at a temperature below 450° C., or at a temperature below 400° C.

In certain embodiments, during the pyrolyzing of the precursor part, the temperature within the chamber increases one or more times at a rate of 10° C./h or more at a temperature above 600° C., or at a temperature above 650° C. or more.

In certain embodiments, during the pyrolyzing of the precursor part, the temperature within the chamber increases one or more times at a rate of less than 10° C./h between 400° C. and 650° C., or between 450° C. and 600° C. . . . In particular the temperature within the chamber can increase at a rate of from about 1° C./h, 2° C./h, 3° C./h, 4° C./h, 5° C./h, 6° C./h, 7° C./h, 8° C./h, 9° C./h, 10° C./h between 400° C. and 650° C., or from 450° C. and 600° C.

In preferred embodiments, during the pyrolyzing of the precursor part the temperature within the chamber increases one or more times at a rate of 10° C./h or more at a temperature below 400° C., at a rate of less than 10° C./h between 450° C. and 600° C., and at a rate of 10° C./h or more at a temperature above 650° C.

In certain embodiments, during the pyrolyzing of the precursor part the temperature within the chamber increases one or more times at a rate of from 10° C./h to 15° C./h at a temperature below 400° C., at a rate of from 2° C./h to 5° C./h between 450° C. and 600° C., and at a rate of from 10° C./h to 15° C./h at a temperature above 650° C.

In certain embodiments, the pyrolyzing optionally can comprise temperature holds during the pyrolysis at temperatures between 120° C. and 1000° C., or between 200° C. and 1000° C., or between 400° C. and 1000° C. In certain embodiments, the pyrolysis can be performed under nitrogen, argon, or forming gas (mixture of hydrogen and nitrogen). In certain embodiments, the pyrolyzing occurs in a graphite bed. In certain embodiments, the temperature holds during the pyrolysis can be from about 1 h to 72 h, from about 2 h to 48 h, or from about 3 h to 24 h. In certain embodiments, the temperature holds (i.e., is maintained) during the pyrolysis can be about 1 h, 2 h, 3 h, 4 h, 5 h, 6 h, 7 h, 8 h, 9 h, 10 h, 12 h, 16 h, 20 h, 24 h, 30 h, 36 h, 42 h, 48 h, 54 h, 60 h, 66 h, 72 h, or any ranges between the specified values.

In certain embodiments, the pyrolyzing of the precursor part can comprise one or more temperature holds during the pyrolysis between 400° C. and 650° C., or between 450° C. and 600° C., temperatures included. In certain embodiments, the pyrolysis of the precursor part can be performed under nitrogen, argon, or forming gas (mixture of hydrogen and nitrogen). In certain embodiments, the pyrolyzing of the precursor part occurs in a graphite bed. In certain embodiments, the temperature holds during the pyrolysis can be from about 1 h to 72 h, from about 2 h to 48 h, or from about 3 h to 24 h. In certain embodiments, the temperature holds (i.e., is maintained) during the pyrolysis of the precursor part can be about 1 h, 2 h, 3 h, 4 h, 5 h, 6 h, 7 h, 8 h, 9 h, 10 h, 12 h, 16 h, 20 h, 24 h, 30 h, 36 h, 42 h, 48 h, 54 h, 60 h, 66 h, 72 h, or any ranges between the specified values.

In certain embodiments, the liquid second resin comprises, consists essentially of, or consists of one or more of pitch, benzoxazines, furfural, polyester, vinylester, acrylic, and phenolics. In certain embodiment, the liquid second resin comprises, consists essentially of, or consist of pitch, phenolics or combination thereof.

In certain embodiments, the method comprises repeating infusing step c, and pyrolyzing step d. at least one time. In certain embodiments, the method comprises repeating infusing step c, and pyrolyzing step d. at least two, three, four, five, or more times. In certain embodiments the char yield after a first pyrolysis cycle or after two, three, four, five, or more times can be greater than 65%, greater than 70%, greater than 75%, greater than 80%, greater than 85%, greater than 90%, or greater than 95% or more.

In certain embodiments, the method comprises repeating infusing step c, and pyrolyzing step d. until the carbon carbon composite, carbon ceramic matrix composite, or carbon silica composite is at least about 75% solid, 80% solid, 85% solid, 90% solid, 95% solid, or 99% solid as determined according to Example

In certain embodiments, the method comprises repeating steps c. through d. one or more times.

### Processing a PAEK Tape or Fabric or Co-Woven PAEK Fiber or Fabric

In certain embodiments, the precursor part of step (a) is made by: processing a tape or fabric or co-woven fibers or fabric made of a PAEK copolymer comprising at least two different repeating units, one of the repeating units being present in an amount of 50 to 78 mol % compared to the total amount of the repeating units constituting the copolymer, and at least one reinforcing material, via one or more the following methods: hand-layup, automated tape placement, 3D printing, filament winding, needle punching, and other methods of Z-axis reinforcement followed by one or more compression molding, vacuum bag consolidation, autoclave consolidation, and in-situ consolidation.

In these embodiments, the reinforcing material is generally a fibrous material.

According to the invention, during the pyrolyzing, a temperature within a chamber increases at a rate of from about 1° C./h to about 20° C./h up to a peak temperature of about 1000° C.

In certain embodiments, during the pyrolyzing the temperature within the chamber can increase at a rate of from about 3° C./h to about 17° C./h. In certain embodiments, during the pyrolyzing, the temperature within the chamber can increase at a rate of from about 5° C./h to about 15° C./h. In certain embodiments, pyrolysis conditions during pyrolyzing step b. are the same as the pyrolysis conditions during pyrolyzing step d. In certain embodiments, the pyrolysis conditions during pyrolyzing step b. are different than the pyrolysis conditions during pyrolyzing step d.

In certain embodiments, during the pyrolyzing, a temperature within a chamber can increase at a rate of from about 1° C./h, 2° C./h, 3° C./h, 4° C./h, 5° C./h, 6° C./h, 7° C./h, 8° C./h, 9° C./h, 10° C./h, 11° C./h, 12° C./h, 13° C./h, 14° C./h, 15° C./h, 16° C./h, 17° C./h, 18° C./h, 19° C./h, 20° C./h, or any ranges between the specified values.

In certain embodiments, during the pyrolyzing of the precursor part, the temperature within the chamber increases one or more times at a rate of 10° C./h or more at a temperature below 450° C., or at a temperature below 400° C.

In certain embodiments, during the pyrolyzing of the precursor part, the temperature within the chamber increases one or more times at a rate of 10° C./h or more at a temperature above 600° C., or at a temperature above 650° C. or more.

In certain embodiments, during the pyrolyzing of the precursor part, the temperature within the chamber increases one or more times at a rate of less than 10° C./h between 400° C. and 650° C., or between 450° C. and 600° C. . . . In particular the temperature within the chamber can increase at a rate of from about 1° C./h, 2° C./h, 3° C./h, 4° C./h, 5° C./h, 6° C./h, 7° C./h, 8° C./h, 9° C./h, 10° C./h between 400° C. and 650° C., or from 450° C. and 600° C.

In preferred embodiments, during the pyrolyzing of the precursor part the temperature within the chamber increases one or more times at a rate of 10° C./h or more at a temperature below 400° C., at a rate of less than 10° C./h between 450° C. and 600° C., and at a rate of 10° C./h or more at a temperature above 650° C.

In certain embodiments, during the pyrolyzing of the precursor part the temperature within the chamber increases one or more times at a rate of from 10° C./h to 15° C./h at a temperature below 400° C., at a rate of from 2° C./h to 5° C./h between 450° C. and 600° C., and at a rate of from 10° C./h to 15° C./h at a temperature above 650° C.

In certain embodiments, the pyrolyzing optionally can comprise temperature holds during the pyrolysis at temperatures between 120° C. and 1000° C., or between 200° C. and 1000° C., or between 400° C. and 1000° C. In certain embodiments, the pyrolysis can be performed under nitrogen, argon, or forming gas (mixture of hydrogen and nitrogen). In certain embodiments, the pyrolyzing occurs in a graphite bed. In certain embodiments, the temperature holds during the pyrolysis can be from about 1 h to 72 h, from about 2 h to 48 h, or from about 3 h to 24 h. In certain embodiments, the temperature holds (i.e., is maintained) during the pyrolysis can be about 1 h, 2 h, 3 h, 4 h, 5 h, 6 h, 7 h, 8 h, 9 h, 10 h, 12 h, 16 h, 20 h, 24 h, 30 h, 36 h, 42 h, 48 h, 54 h, 60 h, 66 h, 72 h, or any ranges between the specified values.

In certain embodiments, the pyrolyzing of the precursor part can comprise one or more temperature holds during the pyrolysis between 400° C. and 650° C., or between 450° C. and 600° C., temperatures included. In certain embodiments, the pyrolysis of the precursor part can be performed under nitrogen, argon, or forming gas (mixture of hydrogen and nitrogen). In certain embodiments, the pyrolyzing of the precursor part occurs in a graphite bed. In certain embodiments, the temperature holds during the pyrolysis can be from about 1 h to 72 h, from about 2 h to 48 h, or from about 3 h to 24 h. In certain embodiments, the temperature holds (i.e., is maintained) during the pyrolysis of the precursor part can be about 1 h, 2 h, 3 h, 4 h, 5 h, 6 h, 7 h, 8 h, 9 h, 10 h, 12 h, 16 h, 20 h, 24 h, 30 h, 36 h, 42 h, 48 h, 54 h, 60 h, 66 h, 72 h, or any ranges between the specified values.

In certain embodiments, the liquid second resin comprises, consists essentially of, or consists of one or more of pitch, benzoxazines, furfural, polyester, vinylester, acrylic, and phenolics. In certain embodiment, the liquid second resin comprises, consists essentially of, or consist of pitch, phenolics or combination thereof.

In certain embodiments, the method comprises repeating infusing step c, and pyrolyzing step d. at least one time. In certain embodiments, the method comprises repeating infusing step c, and pyrolyzing step d. at least two, three, four, five, or more times. In certain embodiments the char yield after a first pyrolysis cycle or after two, three, four, five, or more times can be greater than 65%, greater than 70%, greater than 75%, greater than 80%, greater than 85%, greater than 90%, or greater than 95% or more.

In certain embodiments, the method comprises repeating infusing step c, and pyrolyzing step d. until the carbon carbon composite, carbon ceramic matrix composite, or carbon silica composite is at least about 75% solid, 80% solid, 85% solid, 90% solid, 95% solid, or 99% solid as determined according to Example

In certain embodiments, the method comprises repeating steps c. through d. one or more times.

### Method Comprising Aligned Materials

In certain embodiments, the method for preparing a carbon-carbon composite, a carbon ceramic matrix composite, or a carbon silica composite comprises:
a1) processing an aligned reinforcing material and a resin comprising a PAEK copolymer comprising at least two different repeating units, one of the repeating units being present in an amount of 50 to 78 mol % compared to the total amount of the repeating units constituting the copolymer, to make an aligned reinforcing material PAEK composition to create a fabric, prepreg, or tape comprising the aligned reinforcing material and impregnated PAEK,
a2) processing the fabric, prepreg, or tape comprising the aligned reinforcing material and impregnated PAEK via hand-layup, automated tape placement, 3D printing, filament winding, or needle punching or other methods of Z-axis reinforcement followed by compression molding, vacuum bag consolidation, autoclave consolidation, in-situ consolidation to make a precursor object,
c. pyrolyzing the object to make a pyrolyzed object,
d. infusing a liquid second resin into the pyrolyzed object to make an infused object, and
e. pyrolyzing the infused object to make the carbon carbon composite, the carbon ceramic matrix composite, or the carbon silica composite, and
f. optionally repeating steps c. through d. one or more times.

In certain embodiments, the present disclosure is directed to the carbon carbon composite, carbon ceramic matrix composite, or carbon silica composite made by the method above.

In certain embodiments, the reinforcing material is a 1-2 dimensional flake material or aligned 1-2 dimensional platelet material. It can notably be graphite, graphene, or whiskers.

In certain embodiments, the 1-2 dimensional flake material or 1-2 dimensional platelet material can have a diameter of from about 0.1 mm to 10 mm, from about 0.5 mm to 9 mm, or from about 1 mm to 8 mm. In certain embodiments, the 1-2 dimensional flake material or 1-2 dimensional platelet material can have a diameter of about 0.1 mm, 0.5 mm, 1 mm, 2 mm, 3 mm, 4 mm, 5 mm, 6 mm, 7 mm, 8 mm, 9 mm, 10 mm, and any ranges between the specified values. In certain embodiments, the 1-2 dimensional flake material or 1-2 dimensional platelet material can have a thickness of from about 0.001 mm to 0.1 mm, from about 0.005 mm to 0.09 mm, or from about 0.01 mm to 0.08 mm. In certain embodiments, the 1-2 dimensional flake material or 1-2 dimensional platelet material can have a thickness of about 0.001 mm, 0.005 mm, 0.01 mm, 0.02 mm, 0.03 mm, 0.04 mm, 0.05 mm, 0.06 mm, 0.07 mm, 0.08 mm, 0.09 mm, 0.1 mm, and any ranges between the specified values. Measurements can be obtained from optical or scanning electron microscopy imaging before melt compounding.

In certain embodiments, the processing can create a fabric comprising the aligned reinforcing material and impregnated PAEK. In certain embodiments, the processing can create a prepreg comprising the aligned reinforcing materials and impregnated PAEK. In certain embodiments, the processing can create a tape comprising the aligned reinforcing materials and impregnated PAEK.

In certain embodiments, aligned reinforcing additives can be made by stretching unidirectional tape until the fibers are broken, subjecting the fibers to fluid flow to align the fibers, or subjecting the fibers to electro-magnetic fields to align the fibers. In certain embodiments, the aligned reinforcing additives can be made by stretching unidirectional tape until the fibers are broken (either before or after impregnation with PAEK resin). In a preferred embodiment the fibers are aligned by fluid flow onto a porous belt to create a mat of aligned fibers as described in U.S. Pat. No. 10,669,659.

In certain embodiments, the aligned reinforcing material can be one or more of carbon, glass, silica, boron, natural fibers, polymeric fibers, carbon nanotubes, graphite, graphene, and carbon or ceramic whiskers. In certain embodiments, the natural fibers can be one or more of cellulose, bamboo, hemp, and jute. In certain embodiments, the polymeric fibers can be one or more of polyamide, polyimides, polyaramid, polyurethane, polyester, and polyurethane.

In certain embodiments, the aligned reinforcing material can have a length of from about 0.1 mm to 10 mm, from about 0.5 mm to 9 mm, or from about 1 mm to 8 mm. In certain embodiments, the aligned reinforcing additive can have a fiber length of about 0.1 mm, 0.5 mm, 1 mm, 2 mm, 3 mm, 4 mm, 5 mm, 6 mm, 7 mm, 8 mm, 9 mm, 10 mm, and any ranges between the specified values.

In certain embodiments, the in-situ consolidation can contain rolling to apply pressure and/or heat.

In certain embodiments, during the pyrolyzing, a temperature within a chamber can increase at a rate of from about 1° C./h to about 20° C./h up to a peak temperature of about 1000° C. In certain embodiments, during the pyrolyzing, the temperature within the chamber can increase at a rate of from about 3° C./h to about 17° C./h. In certain embodiments, during the pyrolyzing, the temperature within the chamber can increase at a rate of from about 5° C./h to about 15° C./h. In certain embodiments, the pyrolysis conditions during pyrolyzing step c. are the same as the pyrolysis conditions during pyrolyzing step e. In certain embodiments, the pyrolysis conditions during pyrolyzing step c. are different than the pyrolysis conditions during pyrolyzing step e.

In certain embodiments, during the pyrolyzing, a temperature within a chamber can increase at a rate of from about 1° C./h, 2° C./h, 3° C./h, 4° C./h, 5° C./h, 6° C./h, 7° C./h, 8° C./h, 9° C./h, 10° C./h, 11° C./h, 12° C./h, 13° C./h, 14° C./h, 15° C./h, 16° C./h, 17° C./h, 18° C./h, 19° C./h, 20° C./h, or any ranges between the specified values.

In certain embodiments, during the pyrolyzing of the precursor part, the temperature within the chamber increases one or more times at a rate of 10° C./h or more at a temperature below 450° C., or at a temperature below 400° C.

In certain embodiments, during the pyrolyzing of the precursor part, the temperature within the chamber increases one or more times at a rate of 10° C./h or more at a temperature above 600° C., or at a temperature above 650° C. or more.

In certain embodiments, during the pyrolyzing of the precursor part, the temperature within the chamber increases one or more times at a rate of less than 10° C./h between 400° C. and 650° C., or between 450° C. and 600° C. . . . In particular the temperature within the chamber can increase at a rate of from about 1° C./h, 2° C./h, 3° C./h, 4° C./h, 5° C./h, 6° C./h, 7° C./h, 8° C./h, 9° C./h, 10° C./h between 400° C. and 650° C., or from 450° C. and 600° C.

In preferred embodiments, during the pyrolyzing of the precursor part the temperature within the chamber increases one or more times at a rate of 10° C./h or more at a temperature below 400° C., at a rate of less than 10° C./h between 450° C. and 600° C., and at a rate of 10° C./h or more at a temperature above 650° C.

In certain embodiments, during the pyrolyzing of the precursor part the temperature within the chamber increases one or more times at a rate of from 10° C./h to 15° C./h at a temperature below 400° C., at a rate of from 2° C./h to 5° C./h between 450° C. and 600° C., and at a rate of from 10° C./h to 15° C./h at a temperature above 650° C.

In certain embodiments, the pyrolyzing optionally can comprise temperature holds during the pyrolysis. In certain embodiments, the pyrolysis can be performed under nitrogen, argon, or forming gas. In certain embodiments, the pyrolyzing occurs in a graphite bed. In certain embodiments, the temperature holds during the pyrolysis can be from about 1 h to 72 h, from about 2 h to 48 h, or from about 3 h to 24 h. In certain embodiments, the temperature holds during the pyrolysis can be about 1 h, 2 h, 3 h, 4 h, 5 h, 6 h, 7 h, 8 h, 9 h, 10 h, 12 h, 16 h, 20 h, 24 h, 30 h, 36 h, 42 h, 48 h, 54 h, 60 h, 66 h, 72 h, or any ranges between the specified values.

In certain embodiments, the pyrolyzing of the precursor part can comprise one or more temperature holds during the pyrolysis between 400° C. and 650° C., or between 450° C. and 600° C., temperatures included. In certain embodiments, the pyrolysis of the precursor part can be performed under nitrogen, argon, or forming gas (mixture of hydrogen and nitrogen). In certain embodiments, the pyrolyzing of the precursor part occurs in a graphite bed. In certain embodiments, the temperature holds during the pyrolysis can be from about 1 h to 72 h, from about 2 h to 48 h, or from about 3 h to 24 h. In certain embodiments, the temperature holds (i.e., is maintained) during the pyrolysis of the precursor part can be about 1 h, 2 h, 3 h, 4 h, 5 h, 6 h, 7 h, 8 h, 9 h, 10 h, 12 h, 16 h, 20 h, 24 h, 30 h, 36 h, 42 h, 48 h, 54 h, 60 h, 66 h, 72 h, or any ranges between the specified values.

In certain embodiments, the precursor object can be melt formed after the processing step a, but before the pyrolyzing step c.

In certain embodiments, the liquid second resin can be one or more of pitch, benzoxazines, furfural, polyester, vinylester, acrylic, and phenolics. In certain embodiments, pitch, phenolics, or combination there are preferred.

In certain embodiments, the method comprises repeating infusing step d, and pyrolyzing step e. at least one time. In certain embodiments, the method comprises repeating infusing step d, and pyrolyzing step e. at least two, three, four, or five times. In certain embodiments the char yield after a first pyrolysis cycle or after two, three, four, five, or more times can be greater than 65%, greater than 70%, greater than 75%, greater than 80%, greater than 85%, greater than 90%, or greater than 95% or more.

In certain embodiments, the method comprises repeating infusing step d, and pyrolyzing step e. until the carbon carbon composite, carbon ceramic matrix composite, or carbon silica composite is at least about 75% solid, 80% solid, 85% solid, 90% solid, 95% solid, or 99% solid.

In certain embodiments, steps c. through d. are repeated one or more times.

### Method Comprising Impregnating or Co-Weaving in the Presence of One Reinforcing Additive

In certain embodiments, the present disclosure is directed to a method for making a carbon-carbon composite, a carbon ceramic matrix composite, or a carbon silica composite.

In certain embodiments, the method for making a carbon carbon composite, a carbon ceramic matrix composite, or a carbon silica composite comprises:
a1) impregnating a continuous fiber tape or fabric with a resin comprising with a poly(aryl ether ketone) (PAEK) copolymer comprising at least two different repeating units, one of the repeating units being present in an amount of 50 to 78 mol % compared to the total amount of the repeating units constituting the copolymer, and at least one reinforcing additive to make a filled PEKK tape or fabric,
a2) processing the filled PEKK tape or fabric or co-woven PEKK/fiber material via hand-layup, automated tape placement, 3D printing, filament winding or needle punching or other methods of Z-axis reinforcement followed by compression molding, vacuum bag consolidation, autoclave consolidation, or in-situ consolidation to make a precursor part,
c. pyrolyzing the precursor part to make a pyrolyzed part,
d. infusing a liquid second resin into the pyrolyzed part to make an infused part, and
e. pyrolyzing the infused part to make the carbon carbon composite, the carbon ceramic matrix composite, or the carbon silica composite.

In certain embodiments, the present disclosure is directed to the carbon carbon composite, carbon ceramic matrix composite, or carbon silica composite made by the method above.

In certain embodiments, the method comprises impregnating a continuous fiber tape or fabric with a resin comprising a PAEK and at least one additive to make a filled PAEK tape. In certain embodiments, the method comprises co-weaving a continuous fiber or fabric with a PAEK fiber comprising PAEK and at least one additive to make a filled PAEK tape or fabric.

In certain embodiments, the continuous fiber or fabric can be carbon fiber.

In certain embodiments, the reinforcing additive can be one or more of a carbonaceous additive, a chopped fiber, dispersing agents, and an inorganic additive.

In certain embodiments, the additive can be present in an amount of from about 0.01% to about 30% by weight of the total composition of the resin. In certain embodiments, the additive can be present in an amount of from about 0.1% to about 25% by weight of the total composition of the resin. In certain embodiments, the additive can be present in an amount of from about 1% to about 20% by weight of the total composition of the resin.

In certain embodiments, the additive can be present in an amount of about 0.01%, 0.05%, 0.1%, 0.5%, 1%, 2%, 3%, 4%, 5%, 6%, 7%, 8%, 9%, 10%, 15%, 20%, 25%, 30%, or any ranges between the specified values, based on the weight of the total composition of the resin.

In certain embodiments, the additive can be a carbonaceous additive. In certain embodiments, the carbonaceous additive can be one or more of carbon fiber, carbon nanotubes, graphite, graphene, carbon whisker, a fullerene, carbon black, carbon flake, and buckyballs. In certain embodiments, the carbonaceous additive can be aligned by shear from the melt processing.

In certain embodiments, the carbonaceous additive can have a length of from about 0.1 mm to 10 mm, from about 0.5 mm to 9 mm, or from about 1 mm to 8 mm. In certain embodiments, the carbonaceous additive can have a length of about 0.1 mm, 0.5 mm, 1 mm, 2 mm, 3 mm, 4 mm, 5 mm, 6 mm, 7 mm, 8 mm, 9 mm, 10 mm, and any ranges between the specified values. In certain embodiments, the carbonaceous additive can have a diameter of from about 0.1 μm to 10 μm, from about 0.5 μm to 9 μm, or from about 1 μm to 8 μm. In certain embodiments, the carbonaceous additive can have a diameter of about 0.1 μm, 0.5 μm, 1 μm, 2 μm, 3 μm, 4 μm, 5 μm, 6 μm, 7 μm, 8 μm, 9 μm, 10 μm, and any ranges between the specified values.

In certain embodiments, the additive can be a chopped fiber. In certain embodiments, the chopped fiber comprises one or more of carbon, glass, silica, boron, natural fibers, and polymeric fibers. In certain embodiments, the natural fibers can be one or more of cellulose, bamboo, hemp, and jute. In certain embodiments, the polymeric fibers can be one or more of polyamide, polyimides, polyaramid, polyurethane, polyester, and polyurethane.

In certain embodiments, the chopped fiber is a chopped carbon fiber. The one or more carbon fibers can have a fiber length of from about 0.1 mm to 10 mm, from about 0.5 mm to 9 mm, or from about 1 mm to 8 mm. In certain embodiments, the chopped carbon fiber can have a fiber length of about 0.1 mm, 0.5 mm, 1 mm, 2 mm, 3 mm, 4 mm, 5 mm, 6 mm, 7 mm, 8 mm, 9 mm, 10 mm, and any ranges between the specified values. In certain embodiments, the chopped carbon fiber can have a diameter of from about 0.1 μm to 10 μm, from about 0.5 μm to 9 μm, or from about 1 μm to 8 μm. In certain embodiments, the chopped carbon fiber can have a diameter of about 0.1μ, 0.5 μm, 1μ, 2 μm, 3μ, 4 μm, 5 μm, 6μ, 7 μm, 8 μm, 9 μm, 10 μm, and any ranges between the specified values.

In certain embodiments, the additive can be an inorganic additive. In certain embodiments, the inorganic additive can be one or more of a group IV, V, or VI carbide, silicides, boride, and nitride. Carbides and silicides would be preferred with silicon carbide being the most preferred. In certain embodiments, the inorganic additive can be in powder form. In certain embodiments, the average particle size of the powder can be from about 0.01 μm to 500 μm, from about 0.1 μm to 250 μm, from about 1 μm to 100 μm, or from about 2 μm to 50 μm. In certain embodiments, the average particle size of the powder can be 0.01 μm, 0.1 μm, 0.5 μm, 1 μm, 5 μm, 10μ, 15μ, 20 μm, 25 μm, 30 μm, 40μ, 50 μm, 75 μm, 100 μm, 250 μm, 500 μm, or any ranges between the specified values.

In certain embodiments, the additive can comprise a dispersing agent. In certain embodiments, the dispersing agent can be an organosilicate, oganozirconate, organoaluminate, or oraganotitanate, with organosilicates and organotitanates being preferred and organosilicates being the most preferred. In certain embodiments, dispersing agent can have an average pore size of from about 1 nm to 500 nm, from about 2 nm to 250 nm, or from 3 nm to 100 nm. In certain embodiments, dispersing agent can have an average pore size of about 1 nm, 2 nm, 3 nm, 5 nm, 10 nm, 15 nm, 20 nm, 25 nm, 30 nm, 40 nm, 50 nm, 75 nm, 100 nm, 250 nm, 500 nm, or any ranges between the specified values.

In certain embodiments, the in-situ consolidation can contain rolling to apply pressure and/or heat.

In certain embodiments, during the pyrolyzing, a temperature within a chamber can increase at a rate of from about 1° C./h to about 20° C./h up to a peak temperature of about 1000° C. In certain embodiments, during the pyrolyzing, the temperature within the chamber can increase at a rate of from about 3° C./h to about 17° C./h. In certain embodiments, during the pyrolyzing, the temperature within the chamber can increase at a rate of from about 5° C./h to about 15° C./h. In certain embodiments, the pyrolysis conditions during pyrolyzing step c. are the same as the pyrolysis conditions during pyrolyzing step e. In certain embodiments, the pyrolysis conditions during pyrolyzing step c. are different than the pyrolysis conditions during pyrolyzing step e.

In certain embodiments, during the pyrolyzing, a temperature within a chamber can increases at a rate of from about 1° C./h, 2° C./h, 3° C./h, 4° C./h, 5° C./h, 6° C./h, 7° C./h, 8° C./h, 9° C./h, 10° C./h, 11° C./h, 12° C./h, 13° C./h, 14° C./h, 15° C./h, 16° C./h, 17° C./h, 18° C./h, 19° C./h, 20° C./h, or any ranges between the specified values.

In certain embodiments, during the pyrolyzing of the precursor part, the temperature within the chamber increases one or more times at a rate of 10° C./h or more at a temperature below 450° C., or at a temperature below 400° C.

In certain embodiments, during the pyrolyzing of the precursor part, the temperature within the chamber increases one or more times at a rate of 10° C./h or more at a temperature above 600° C., or at a temperature above 650° C. or more.

In certain embodiments, during the pyrolyzing of the precursor part, the temperature within the chamber increases one or more times at a rate of less than 10° C./h between 400° C. and 650° C., or between 450° C. and 600° C. . . . In particular the temperature within the chamber can increase at a rate of from about 1° C./h, 2° C./h, 3° C./h, 4° C./h, 5° C./h, 6° C./h, 7° C./h, 8° C./h, 9° C./h, 10° C./h between 400° C. and 650° C., or from 450° C. and 600° C.

In preferred embodiments, during the pyrolyzing of the precursor part the temperature within the chamber increases one or more times at a rate of 10° C./h or more at a temperature below 400° C., at a rate of less than 10° C./h between 450° C. and 600° C., and at a rate of 10° C./h or more at a temperature above 650° C.

In certain embodiments, during the pyrolyzing of the precursor part the temperature within the chamber increases one or more times at a rate of from 10° C./h to 15° C./h at a temperature below 400° C., at a rate of from 2° C./h to 5° C./h between 450° C. and 600° C., and at a rate of from 10° C./h to 15° C./h at a temperature above 650° C.

In certain embodiments, the pyrolyzing optionally can comprise temperature holds during the pyrolysis. In certain embodiments, the pyrolysis can be performed under nitrogen, argon, or forming gas. In certain embodiments, the pyrolyzing occurs in a graphite bed. In certain embodiments, the temperature holds during the pyrolysis can be from about 1 h to 72 h, from about 2 h to 48 h, or from about 3 h to 24 h. In certain embodiments, the temperature holds during the pyrolysis can be about 1 h, 2 h, 3 h, 4 h, 5 h, 6 h, 7 h, 8 h, 9 h, 10 h, 12 h, 16 h, 20 h, 24 h, 30 h, 36 h, 42 h, 48 h, 54 h, 60 h, 66 h, 72 h, or any ranges between the specified values.

In certain embodiments, the pyrolyzing of the precursor part can comprise one or more temperature holds during the pyrolysis between 450° C. and 600° C., temperatures included. In certain embodiments, the pyrolysis of the precursor part can be performed under nitrogen, argon, or forming gas (mixture of hydrogen and nitrogen). In certain embodiments, the pyrolyzing of the precursor part occurs in a graphite bed. In certain embodiments, the temperature holds during the pyrolysis can be from about 1 h to 72 h, from about 2 h to 48 h, or from about 3 h to 24 h. In certain embodiments, the temperature holds (i.e., is maintained) during the pyrolysis of the precursor part can be about 1 h, 2 h, 3 h, 4 h, 5 h, 6 h, 7 h, 8 h, 9 h, 10 h, 12 h, 16 h, 20 h, 24 h, 30 h, 36 h, 42 h, 48 h, 54 h, 60 h, 66 h, 72 h, or any ranges between the specified values.

In certain embodiments, the precursor object can be melt formed after the processing step b, but before the pyrolyzing step c.

In certain embodiments, the liquid second resin can be one or more of pitch, benzoxazines, furfural, polyester, vinylester, acrylic, and phenolics.

In certain embodiments, the method comprises repeating infusing step d, and pyrolyzing step e. at least one time. In certain embodiments, the method comprises repeating infusing step d, and pyrolyzing step e. at least two, three, four, or five times or more. In certain embodiments the char yield after a first pyrolysis cycle or after two, three, four, five, or more times can be greater than 65%, greater than 70%, greater than 75%, greater than 80%, greater than 85%, greater than 90%, or greater than 95% or more.

In certain embodiments, the method comprises repeating infusing step d, and pyrolyzing step e. until the carbon carbon composite, carbon ceramic matrix composite, or carbon silica composite is at least about 75% solid, 80% solid, 85% solid, 90% solid, 95% solid, or 99% solid.

### EXAMPLES

The method and products described herein are now further detailed with reference to the following examples. These examples are provided for the purpose of illustration only and the embodiments described herein should in no way be construed as being limited to these examples. Rather, the embodiments should be construed to encompass any and all variations which become evident as a result of the teaching provided herein.

### Example 1: Influence of T/I Ratio for PEKK Samples

PEKK with varying T/I ratios (60/40; 80/20) and 30% chopped fibers (either glass or carbon), and neat PEKK or PEEK samples (“Table 1”) were fabricated by injection molding and pyrolyzed in a quartz crucible in a muffle furnace in an inert environment undergoing the pyrolysis cycle as described in Table 2. Their initial dimensions were all around: 5.1 cm×1.3 cm×0.3 cm. The PEEK was a homopolymer made of repeating units of formula (III).

TABLE 1

| Sample | Polymer | T/I Ratio | Fibre type | Fibre Content |
|---|---|---|---|---|
| EXAMPLE A | PEKK | 60/40 | glass | 30% |
| COMP B | PEKK | 80/20 | carbon | 30% |
| COMP C | PEKK | 60/40 | — | — |
| COMP D | PEEK | — | — | — |
| | (homopolymer) | | | |

TABLE 2

| | | Time | Temperature |
|---|---|---|---|
| Step | Temperature (° C.) | (hours) | ramp (° C./hr) |
| 1 | 23-120 | 2 | 47.5 |
| 2 | hold 120 | 2 | — |
| 3 | 120-450 | 24 | 13.8 |
| 4 | hold 450 | 4 | — |
| 5 | 450-600 | 48 | 3.1 |
| 6 | hold 600 | 4 | — |
| 7 | 600-1000 | 28 | 14.3 |
| 8 | hold 1000 | 3 | — |
| | Total time (hours) | 115 | |

Samples A and B were weighed and their thickness (t) was measured before and after pyrolysis to calculate char yield and determine dimensional change (“Table 3”).

Char yield was calculated from the mass of each sample pre and post pyrolysis (“Equation 1”):

$$char yield ( \% ) = \frac{{w}_{a}}{{w}_{b}} \times 100$$

where w_{b} and wₐ are the mass of the sample before and after pyrolysis respectively.

The parameter Δt was calculated by doing the difference between the thickness after the pyrolysis and the thickness, at 25° C. before the pyrolysis, divided by the thickness, at 25° C. before the pyrolysis, expressed as a percentage.

TABLE 3

| Sample | Char Yield (%) | Δt (%) |
|---|---|---|
| EXAMPLE A | 77.6 | 51.6 |
| COMP B | 76.3 | 152 |
| COMP C | 69.5 | Not measured |
| COMP D | 57.0 | Not measured |

Neat PEKK exhibited much higher char yield (Sample C) when pyrolyzed compared to neat PEEK (Sample D). PEKK repeat units are therefore preferred compared to PEEK repeat units.

PEKK having a T:I ratio of 60:40 and filled with chopped fibers (Sample A) when compared to PEKK having a T:I ratio of 80:20 filled with chopped fibers (Sample B) exhibited a slight improvement in char yield and an almost 3× reduction in sample bloating, as measured by dimensional changes in thickness. This shows that there is an optimum in PAEK copolymer repeat units ratio to minimize bloating while obtaining at the same time a similar char yield.

1. A method for making a high temperature composite, which is a carbon carbon composite, a carbon ceramic matrix composite, or a carbon silica composite, comprising:
a. making a precursor part from a resin comprising a poly(aryl ether ketone) (PAEK) copolymer comprising at least two different repeating units, one of the repeating units being present in an amount of 50 to 78 mol % compared to the total amount of the repeating units constituting the copolymer, and at least one reinforcing material;
b. pyrolyzing the precursor part to a pyrolyzed part;
c. infusing a liquid second resin into the pyrolyzed part to make an infused part; and
d. pyrolyzing the infused part to make the carbon carbon composite, the carbon ceramic matrix composite, or the carbon silica composite,
optionally repeating steps c. through d. one or more times.

2. The method of claim 1, wherein the PAEK copolymer essentially consists of, or consists of two repeating units.

3. The method of claim 2, wherein the PAEK copolymer is a polyetherketoneketone (PEKK) having a T:I ratio of from 50:50 to 78:22.

4. The method of claim 2, wherein the PEKK has a T:I ratio of about 55:45 to about 65:35.

5. The method of claim 2, wherein the PEKK has a T:I ratio of about 65:35 to about 75:25.

6. The method of claim 1, wherein during the pyrolyzing, a temperature within a chamber increases to a peak temperature of about 1000° C. or more,
wherein said temperature within the chamber increases one or more times at a rate from 1° C./h to about 20° C./h during said pyrolyzing, and wherein optionally said pyrolyzing is maintained for a period of time at one or more temperatures.

7. The method according to claim 1, wherein during the pyrolyzing of the precursor part, the temperature within the chamber increases one or more times at a rate of less than 10° C./h between 450° C. and 600° C., and is optionally maintained for a period of time at one or more temperatures between 450° C. and 600° C., temperatures included.

8. The method according to claim 1, wherein during the pyrolyzing of the precursor part, the temperature within the chamber increases one or more times at a rate of 10° C./h or more at temperatures below 400° C. and/or above 650° C.

9. The method according to claim 1, wherein the liquid second resin comprises one or more of pitch, benzoxazines, furfural, polyester, vinylester, acrylic, and phenolics.

10. The method according to claim 1, wherein the precursor part is made by melt processing the resin comprising the poly(aryl ether ketone) and the at least one reinforcing material.

11. The method according to claim 10, wherein the melt processing comprises one or more of injection molding, extrusion, roto-molding, compression molding, pultrusion, filament winding, and fused filament fabrication printing.

12. The method according to claim 1, wherein the precursor part of step (a) is made by:
a1) impregnating a continuous fiber tape or fabric with a resin comprising a poly(aryl ether ketone) (PAEK) copolymer comprising at least two different repeating units, one of the repeating units being present in an amount of 50 to 78 mol % compared to the total amount of the repeating units constituting the copolymer, and at least one reinforcing additive to make a filled PAEK tape or fabric or, co-weaving a continuous fiber or fabric with a PAEK fiber comprising PAEK and the at least one reinforcing additive to make a filled co-woven PAEK fiber or fabric; and
a2) processing the filled PAEK tape or fabric or co-woven PAEK fiber or fabric via one or more the following methods: hand-layup, automated tape placement, 3D printing, filament winding, needle punching, and other methods of Z-axis reinforcement followed by one or more compression molding, vacuum bag consolidation, autoclave consolidation, and in-situ consolidation, to make the precursor part.

13. The method according to claim 1, wherein the precursor part of step (a) is made by:
a1) processing an aligned reinforcing material and a resin comprising a PAEK copolymer comprising at least two different repeating units, one of the repeating units being present in an amount of 50 to 78 mol % compared to the total amount of the repeating units constituting the copolymer, to make an aligned reinforcing material PAEK composition, to create a fabric, prepreg, or tape comprising the aligned reinforcing material and impregnated PAEK,
a2) processing the fabric, prepreg, or tape comprising the aligned reinforcing material and impregnated PAEK via hand-layup, automated tape placement, 3D printing, filament winding, or needle punching or other methods of Z-axis reinforcement followed by compression molding, vacuum bag consolidation, autoclave consolidation, in-situ consolidation to make a precursor object.

14. The method according to claim 1, wherein the reinforcing material comprises one or more reinforcing additives chosen among a carbonaceous additive, a chopped fiber, an inorganic additive, or mixtures thereof; a fibrous material comprising long fibers, continuous fibers, or mixtures thereof; or mixtures thereof.

15. The method according to claim 1, wherein the reinforcing material comprises a carbonaceous additive being one or more of carbon fiber, carbon nanotubes, graphite, graphene, carbon whisker, a fullerene, carbon black, carbon flake, buckyballs and mixtures thereof.

16. The method according to claim 1, wherein the reinforcing material comprises a chopped, long, or continuous fiber being one or more of carbon, glass, silica, boron, natural fibers, polymeric fibers and mixtures thereof.

17. The method according to claim 1, wherein the reinforcing material comprises an inorganic additive being one or more of a group IV, V, or VI carbide, silicide, boride, or nitride, and/or ceramic whiskers.

18. The method according to claim 1, wherein the precursor part comprises a dispersing agent being an organosilicate, oganozirconate, organoaluminate or oraganotitanate.

19. The method according to claim 1, wherein the reinforcing material is a chopped carbon fiber or a chopped glass fiber.

20. The method according to claim 1, wherein the reinforcing material is a long or continuous carbon fiber, or a long or continuous glass fiber.

21. The method according to claim 1, wherein the reinforcing material is a mixture of chopped fibers and, long or continuous fibers.

22. The method according to claim 1, wherein the precursor part of step (a) is made by: processing a tape or fabric or co-woven PAEK fiber or fabric made of a PAEK copolymer comprising at least two different repeating units, one of the repeating units being present in an amount of 50 to 78 mol % compared to the total amount of the repeating units constituting the copolymer, and at least one reinforcing material, via one or more the following methods: hand-layup, automated tape placement, 3D printing, filament winding, needle punching, and other methods of Z-axis reinforcement followed by one or more compression molding, vacuum bag consolidation, autoclave consolidation, and in-situ consolidation.

23. A carbon carbon composite, carbon ceramic matrix composite, or carbon silica composite made by the method according to claim 1.
